(19) United States
(12) Patent Application Publication
(10) Pub. No.: US 2009/0176471 A1
(43) Pub. Date: Jul. 9, 2009

(54) RECEIVER

(76) Inventor: Kazuhisa ISHIGURO, Ota-shi (JP)

Correspondence Address: SMITH PATENT OFFICE, 1901 PENNSYLVANIA AVENUE N W, SUITE 901, WASHINGTON, DC, 20006, US

(21) Appl. No.: 12/350,276

(22) Filed: Jan. 8, 2009

(30) Foreign Application Priority Data
Jan. 9, 2008 (JP) 2008-001791

(51) Int. Cl. H04B 1/10

(52) U.S. Cl. 455/317

(57) ABSTRACT

A first FE circuit (1) including a first mixer (1a) and a second FE circuit (2) including a second mixer (2a) are provided, and either the first FE circuit (1) or the second FE circuit (2) is selectively used corresponding to a level of a disturbing wave contained in a received radio frequency signal. Thus, it is possible to increase a receiving sensitivity by using the first mixer (1a) having a great mutual conductance when the level of the disturbing wave is lower than a predetermined threshold (an improvement in the receiving sensitivity is more important than that in a disturbing characteristic) and to enhance the disturbing characteristic by using the second mixer (2a) having a small mutual conductance when the level of the disturbing wave is equal to or higher than the predetermined threshold (the improvement in the disturbing characteristic is more important than that in the receiving sensitivity).

### BACKGROUND OF THE INVENTION

1. Field of the Invention

The present invention relates to a receiver and more particularly to a technique for improving a receiving sensitivity and a disturbing characteristic of the receiver.

2. Description of the Related Art

As an index for evaluating a performance of a receiver, a receiving sensitivity (a noise factor: NF) and a selectivity (a disturbance eliminating capability) have widely been known. The receiving sensitivity is defined by an S/N ratio, a distortion ratio or the like and implies a minimum input signal level required for obtaining an output on a condition determined for the receiver. The selectivity is also referred to as a disturbing characteristic and implies a capability for eliminating a disturbing signal in another frequency band so as not to be required when the same disturbing signal is given when a signal in a target frequency band is received.

In case of a receiver for carrying out a frequency conversion by a mixer of a front end portion, a disturbing receipt related to a selectivity includes a spurious receipt and an intermodulation (an intermodulation disturbance). The spurious receipt implies a phenomenon to receive a signal in an original unnecessary frequency band which has a certain frequency relationship with a signal having a target frequency. A so-called image disturbance is also a kind of the spurious receipt. The intermodulation implies a phenomenon to disturb the receipt of the target signal when a spurious frequency of a distortion component caused by a nonlinearity of an input/output characteristic of a circuit is superposed on a frequency of a target signal.

In general, the receiver includes an LNA (Low Noise Amplifier) and a mixer in a front end portion of an antenna input stage and further includes circuits such as a band-pass filter (BPF), an IF (Intermediate Frequency) amplifier and a demodulating circuit in a plurality of subsequent stages. A noise (a signal distortion) is made in the circuit of each stage. When a gain of the LNA positioned in an initial stage of the receiver is increased, an influence of a noise factor of the circuit connected to a subsequent stage thereto is reduced so that the noise factor of the LNA is predominant over a noise factor of the whole receiver. When the gain is increased, the noise factor of the LNA itself is improved more greatly. In order to enhance the receiving sensitivity of the whole receiver, accordingly, it is preferable to increase the gain of the LNA.

In the case in which an LNA having a great gain is used, however, there is a drawback that a disturbing characteristic is deteriorated due to a limitation of a dynamic range of the LNA or the like. More specifically, when an LNA having a great gain is used to improve a receiving sensitivity, the disturbing characteristic is deteriorated. To the contrary, when an LNA having a small gain is used to improve the disturbing characteristic, the receiving sensitivity is deteriorated. Thus, it is difficult to cause the improvements in the receiving sensitivity and the disturbing characteristic to be compatible with each other by using an LNA having a fixed gain.

There is an AGC (Automatic Gain Control) technique for detecting a level of a received signal, thereby causing a gain of an LNA to be variable corresponding to the receiving level thus detected. For example, an RF (Radio Frequency)—AGC circuit variably controls the gain of the LNA corresponding to a receiving level, thereby regulating a gain of a radio frequency signal received through an antenna (for example, see Patent Document 1).

[Patent Document 1] WO2005/053171 Publication

### DISCLOSURE OF THE INVENTION

In a receiver provided in an on-vehicle audio device, it is hard to cause a receiving sensitivity and a disturbing characteristic to be compatible with each other in many cases. More specifically, it is necessary to generally use an LNA in order to enhance the receiving sensitivity. On the other hand, there is employed means for directly inputting a received signal to a mixer without using the LNA in order to enhance the disturbing characteristic in some cases. In these cases, however, the LNA is not provided. For this reason, the receiving sensitivity is deteriorated. In some cases, therefore, there is employed means for enhancing a noise factor of the mixer. In these cases, the disturbing characteristic is deteriorated.

In order to solve the problems, it is an object of the present invention to cause improvements in a receiving sensitivity and a disturbing characteristic to be compatible with each other also in a receiver which does not include an LNA.

In order to attain the object, in the present invention, a first front end circuit including a first mixer and a second front end circuit including a second mixer are provided and the first mixer and the second mixer have a structure in which a mutual conductance of a circuit constituting the first mixer is greater than that in the second mixer. Either the first front end circuit or the second front end circuit is selectively used corresponding to a level of a disturbing wave contained in a received radio frequency signal.

According to the present invention having the structure described above, for example, the first front end circuit is selected when the level of the disturbing wave is lower than a predetermined threshold, and the second front end circuit is selected when the level of the disturbing wave is equal to or higher than the predetermined threshold. When the level of the disturbing wave is lower than the predetermined threshold, the improvement in the receiving sensitivity is more important than that in the disturbing characteristic. The first mixer provided in the first front end circuit selected at this time has such a structure that a mutual conductance is comparatively increased. Therefore, it is possible to enhance the receiving sensitivity more greatly as compared with the case in which the second front end circuit is selected.

On the other hand, when the level of the disturbing wave is equal to or higher than the predetermined threshold, the improvement in the disturbing characteristic is more important than that in the receiving sensitivity. The second mixer provided in the second front end circuit selected at this time has such a structure that the mutual conductance is comparatively reduced. Accordingly, it is possible to enhance the disturbing characteristic more greatly as compared with the case in which the first front end circuit is selected. According to the present invention, thus, it is possible to cause the improvement in the receiving sensitivity and that in the disturbing characteristic to be compatible with each other corresponding to the level of the disturbing wave also in an environment in which an LNA is not provided and an AGC operation cannot be carried out.

### BRIEF DESCRIPTION OF THE DRAWINGS

FIG. 1 is a diagram showing an example of a structure of a receiver according to the present embodiment,

FIG. 2 is a diagram showing an example of a structure of a first mixer according to the present embodiment, and

FIG. 3 is a diagram showing an example of a structure of a second mixer according to the present embodiment.

### DETAILED DESCRIPTION OF THE PREFERRED EMBODIMENTS

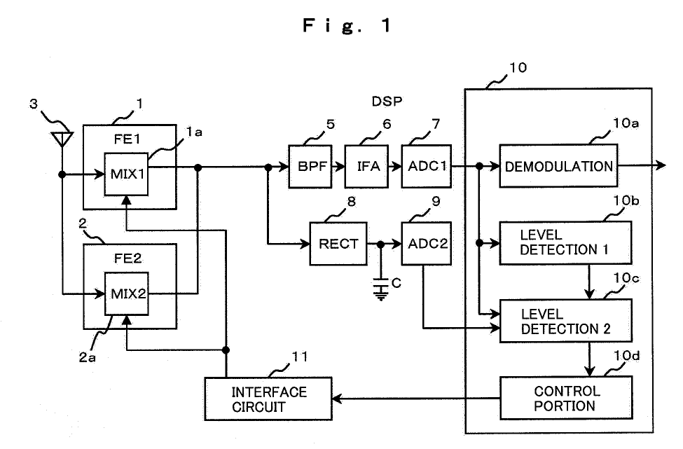

An embodiment according to the present invention will be described below with reference to the drawings. FIG. 1 is a diagram showing an example of a structure of a receiver according to the present embodiment. As shown in FIG. 1, the receiver according to the present embodiment includes a first front end (FE) circuit 1, a second FE circuit 2, an antenna 3, a band-pass filter (BPF) 5, an IF amplifier 6, a first A/D converting circuit 7, a rectifying circuit 8, a second A/D converting circuit 9, a DSP (Digital Signal Processor) 10 and an interface circuit 11. These structures (excluding the antenna 3) are integrated into a single semiconductor chip through a CMOS (Complementary Metal Oxide Semiconductor) process, for example.

The first FE circuit 1 includes a first mixer 1a for frequency-converting a radio frequency signal (an RF signal) received through the antenna 3. The first mixer 1a mixes the RF signal received through the antenna 3 with a local oscillating signal supplied from a local oscillating circuit which is not shown, and carries out a frequency conversion and generates and outputs an intermediate frequency signal (an IF signal). The first FE circuit 1 is a so-called direct mixer type front end circuit, and does not include a radio frequency amplifying circuit such as an LNA but is constituted to connect the antenna 3 to the BPF 5 (the LNA is not provided between the antenna 3 and the first mixer 1a).

The second FE circuit 2 includes a second mixer 2a for frequency-converting the RF signal received through the antenna 3. The second mixer 2a mixes the RF signal received through the antenna 3 with the local oscillating signal supplied from the local oscillating circuit which is not shown, and carries out the frequency conversion and generates and outputs an IF signal. The second FE circuit 2 is also a so-called direct mixer type front end circuit, and does not include the radio frequency amplifying circuit such as the LNA but is constituted to connect the antenna 3 to the BPF 5 (the LNA is not provided between the antenna 3 and the second mixer 2a).

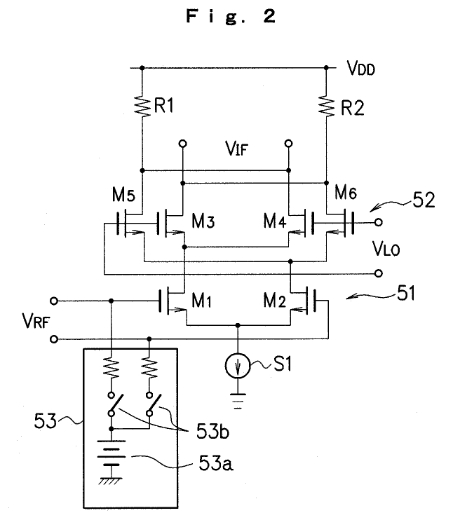

FIG. 2 is a diagram showing an example of a circuit structure of the first mixer 1a provided in the first FE circuit 1. As shown in FIG. 2, the first mixer 1a is a double balance mixer and includes a differential input circuit 51 constituted by a pair of transistors M1 and M2 between a pair of radio frequency signal input terminals for inputting an RF signal V_{RF}. The differential input circuit 51 has a common source structure in which sources of the differential pair transistors M1 and M2 are connected in common and a constant current circuit S1 is connected to a common source point. Moreover, the RF signals V_{RF} are input to gates of the differential pair transistors M1 and M2. If the RF signals V_{RF} input to the gates of the differential pair transistors M1 and M2 have opposite phases which are shifted from each other by 180°, the constant current circuit S1 does not need to be provided.

A bias of the differential input circuit 51 is supplied from a bias circuit 53. The bias circuit 53 includes a bias generating circuit 53a for generating a bias voltage and a switch circuit 53b (constituted by a transistor) for switching a presence of a supply of the bias voltage. When the switch circuit 53b is turned OFF, the supply of the bias to the differential input circuit 51 is blocked so that the first mixer 1a is brought into a floating state and is disconnected from a signal processing system.

Furthermore, a double balance circuit 52 constituted by two sets of differential pair transistors {(M3, M4), (M5, M6)} is disposed between a pair of local signal input terminals for inputting a local oscillating signal V_{LO}. More specifically, the double balance circuit 52 is constituted as follows.

In other words, sources of the differential pair transistors M3 and M4 are connected in common and sources of the differential pair transistors M5 and M6 are connected in common. The common source of the differential pair transistors M3 and M4 is connected to a drain of the transistor M1 constituting the differential input circuit 51. Moreover, the common source of the differentia pair transistors M5 and M6 is connected to a drain of the transistor M2 constituting the differential input circuit 51.

In addition, a gate of the transistor M3 and that of the transistor M5 are connected in common and a gate of the transistor M4 and that of the transistor M6 are connected in common. The local oscillating signal V_{LO} is input to each of the gates.

Moreover, a drain of the transistor M3 and that of the transistor M6 are connected in common and a drain of the transistor M4 and that of the transistor M5 are connected in common. These two sets of common drains are connected to an intermediate frequency signal output terminal pair for outputting an IF signal V_{IF} subjected to a frequency conversion. Moreover, the two sets of common drains are connected to a power supply VDD through resistors R1 and R2, respectively.

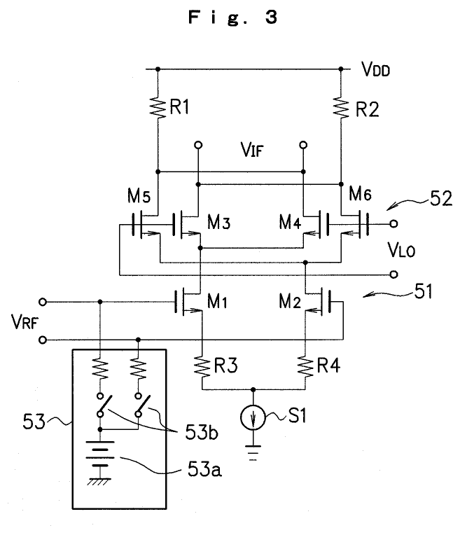

FIG. 3 is a diagram showing an example of a circuit structure of the second mixer 2a provided in the second FE circuit 2. In FIG. 3, portions having the same designations as those shown in FIG. 2 have the same functions. Therefore, repetitive description will be omitted. As shown in FIG. 3, the second mixer 2a includes resistors R3 and R4 in addition to the structure of the first mixer 1a.

The resistors R3 and R4 have ends connected to sources of differential pair transistors M1 and M2 and the other ends connected to a constant current circuit S1 in common. The other portions are the same as those in the first mixer 1a shown in FIG. 2. Thus, the second mixer 2a has such a structure that a mutual conductance of a whole circuit is smaller than that in the first mixer 1a through the connection of the resistors R3 and R4 to the sources of the differential pair transistors M1 and M2 constituting a differential input circuit 51.

By increasing the mutual conductance of the circuit, it is possible to implement a low noise. Therefore, it is possible to enhance a receiving sensitivity. In other words, in the present embodiment, the first mixer 1a having a great mutual conductance is constituted as a useful circuit for an improvement in the receiving sensitivity. Moreover, the second mixer 2a having a small mutual conductance is constituted as a useful circuit for an improvement in a disturbing characteristic.

The switch circuit 53b included in the bias circuit 53 provided in the first mixer 1a and a switch circuit 53b included in a bias circuit 53 provided in the second mixer 2a function as circuits for selecting either the first FE circuit 1 (the first mixer 1a) or the second FE circuit 2 (the second mixer 2a) as a front end circuit to be used. The switching operation of the switch circuit 53b is controlled by the interface circuit 11 (which will be described below in detail).

Returning to FIG. 1, description will be given. The BPF 5 carries out a band limitation for an IF signal supplied from either the first FE circuit 1 or the second FE circuit 2 and extracts a narrowband IF signal including only a desirable wave frequency. The IF amplifier 6 amplifies the narrowband IF signal output from the BPF 5. The first A/D converting circuit 7 analog/digital converts the narrowband IF signal output from the IF amplifier 6. A narrowband digital IF signal thus converted into digital data is input to the DSP 10.

The DSP 10 includes a demodulating portion 10a, a first level detecting portion 10b, a second level detecting portion 10c and a control portion 10d as functional structures thereof. The demodulating portion 10a demodulates, into a baseband signal, the narrowband digital IF signal input from the first A/D converting circuit 7 and outputs the baseband signal.

The rectifying circuit 8 rectifies a broadband IF signal output from either the first FE circuit 1 or the second FE circuit 2. A smoothing capacitor C is connected to a subsequent stage to the rectifying circuit 8. The second A/D converting circuit 9 analog/digital converts the broadband IF signal changed into a direct current through the rectifying circuit 8 and the smoothing capacitor C. A broadband digital IF signal thus converted into digital data is input to the DSP 10.

The first level detecting portion 10b of the DSP 10 detects a receiving electric field strength of a desirable wave frequency (an antenna level of a desirable wave) contained in the RF signal received through the antenna 3 based on the narrowband digital IF signal input from the first A/D converting circuit 7. Moreover, the second level detecting portion 10c corresponds to a disturbing wave detecting portion according to the present invention and detects a receiving electric field strength of a disturbing wave frequency (an antenna level of a disturbing wave) contained in the RF signal received through the antenna 3 based on the narrowband digital IF signal input from the first A/D converting circuit 7 and the broadband digital IF signal input from the second A/D converting circuit 9.

Description will be given to a method of detecting the antenna level of the desirable wave and that of the disturbing wave through the DSP 10. First of all, an antenna level V_{D} of the desirable wave can be obtained by a calculation expressed in the following (Formula 1).

V_{D}=V_{IFN}+G_{RF}+G_{IF} (Formula 1)

V_{IFN}: an IF amplifier output level of a desirable wave

G_{RF}: a gain of an RF stage (either of the FE circuits 1 and 2 which is selected)

G_{IF}: a gain of the IF amplifier 6

The narrowband IF signal containing only the desirable wave frequency is input from the first A/D converting circuit 7 to the DSP 10. By detecting a level of the IF signal input from the first A/D converting circuit 7 to the DSP 10 through the first level detecting portion 10b, accordingly, it is possible to easily obtain the IF amplifier output level V_{IFN} of the desirable wave.

Moreover, neither the first FE circuit 1 nor the second FE circuit 2 include the LNA and carry out an AGC operation. Therefore, the gain G_{RF} of the RF stage is fixed. Accordingly, it is possible to previously grasp the gain G_{RF} of the RF stage in the DSP 10. Moreover, the gain G_{IF} of the IF amplifier 6 is regulated by the DSP 10 so as not to exceed a maximum input of the first A/D converting circuit 7, which is not shown. Therefore, the DSP 10 grasps the gain G_{IF} of the IF amplifier 6.

On the other hand, the broadband digital IF signal input from the second A/D converting circuit 9 to the DSP 10 contains both a desirable wave frequency and a disturbing wave frequency. Accordingly, a signal level V_{IFW} is expressed in the following (Formula 2).

V_{IFW}=√ {(V_{D}(G_{RF}+G_{REC}))²+(V_{UD}(G_{RF}+G_{REC}))²} (Formula 2)

V_{UD}: an antenna level of a disturbing wave

G_{REC}: a gain of the rectifying circuit 8

The gain G_{REC} of the rectifying circuit 8 has a fixed value. Therefore, it is possible to previously grasp the gain G_{REC} through the DSP 10. If the level V_{IFW} of the broadband digital IF signal and the IF amplifier output level V_{IFN} of the desirable wave are calculated by the (Formula 1) and the (Formula 2), accordingly, it is possible to obtain the antenna level V_{UD} of the disturbing wave. As described above, the DSP 10 can easily obtain the IF amplifier output level V_{IFN} of the desirable wave by detecting the level of the IF signal input from the first A/D converting circuit 7. Moreover, the DSP 10 can easily obtain the level V_{IFW} of the broadband digital IF signal by detecting the level of the IF signal input from the second A/D converting circuit 9.

The control portion 10d of the DSP 10 generates a control signal for selecting either the first FE circuit 1 or the second FE circuit 2 based on the antenna level V_{UD} of the disturbing wave which is detected by the second level detecting portion 10c and supplies the control signal to the interface circuit 11. The interface circuit 11 changes over the switch circuits 53b provided in the first mixer 1a and the second mixer 2a respectively based on the control signal supplied from the DSP 10. A selecting portion according to the present invention is constituted by the control portion 10d, the interface circuit 11 and the switch circuit 53b.

The selecting portion selects the first FE circuit 1 when the antenna level V_{UD} of the disturbing wave which is detected by the second level detecting portion 10c is lower than a predetermined threshold. More specifically, the switch circuit 53b provided in the first mixer 1a is turned ON and the switch circuit 53b provided in the second mixer 2a is turned OFF. On the other hand, when the antenna level V_{UD} of the disturbing wave which is detected by the second level detecting portion 10c is equal to or higher than the predetermined threshold, the second FE circuit 2 is selected. More specifically, the switch circuit 53b provided in the first mixer 1a is turned OFF and the switch circuit 53b provided in the second mixer 2a is turned ON.

When the antenna level V_{UD} of the disturbing wave is lower than the predetermined threshold, an improvement in the receiving sensitivity is more important than that in the disturbing characteristic. The first mixer 1a provided in the first FE circuit 1 selected by the switch circuit 53b at this time has such a structure that a mutual conductance is greater than that in the second mixer 2a provided in the second FE circuit 2 (see FIG. 2). Accordingly, the receiving sensitivity can be set to be higher than that in the case in which the second FE circuit 2 is selected and used.

On the other hand, when the antenna level V_{UD} of the disturbing wave is equal to or higher than the predetermined threshold, the improvement in the disturbing characteristic is more important than that in the receiving sensitivity. The second mixer 2a provided in the second FE circuit 2 selected by the switch circuit 53b at this time has such a structure that the mutual conductance is greater than that in the first mixer 1a provided in the first FE circuit 1 (see FIG. 3). Accordingly, the disturbing characteristic can be set to be more excellent than that in the case in which the first FE circuit 1 is selected and used.

As described above in detail, according to the present embodiment, it is possible to cause the improvements in the receiving sensitivity and the disturbing characteristic to be compatible with each other also in an environment in which the LNA is not provided in the front end circuit and the AGC operation cannot be carried out.

In the embodiment, the description has been given to the structure of the direct mixer type in which neither of the FE circuits 1 and 2 includes the LNA. Although the present embodiment is particularly effective for a receiver including the direct mixer type front end circuit which cannot carry out the AGC operation, it can also be applied to a receiver in which the front end circuit includes the LNA.

Moreover, the method of detecting the disturbing wave level V_{UD} described in the embodiment is only illustrative and the disturbing wave level V_{UD} may be detected by the other methods Although the disturbing wave level V_{UD} is detected through the digital signal processing of the DSP 10 in the embodiment, for example, the disturbing wave level V_{UD} may be detected through an analog signal processing.

In addition, the embodiment is only illustrative for a concreteness to carry out the present invention and the technical range of the present invention should not be construed to be restrictive. In other words, the present invention can be carried out in various forms without departing from the spirit or main features thereof.

This application is based on Japanese Patent Application No. 2008-001791 filed on Jan. 9, 2008, the contents of which are incorporated hereinto by reference.

What is claimed is:

1. A receiver comprising:
a first front end circuit including a first mixer for frequency converting a radio frequency signal received through an antenna;
a second front end circuit including a second mixer for frequency converting the radio frequency signal received through the antenna;
a disturbing wave detecting portion for detecting a level of a disturbing wave contained in the radio frequency signal received through the antenna; and
a selecting portion for selecting either the first front end circuit or the second front end circuit corresponding to the level of the disturbing wave which is detected by the disturbing wave detecting portion,
wherein the first mixer has such a structure that a mutual conductance of the circuit is greater than that in the second mixer.

2. The receiver according to claim 1, wherein the selecting portion selects the first front end circuit when the level of the disturbing wave which is detected by the disturbing wave detecting portion is lower than a predetermined threshold, and selects the second front end circuit when the level of the disturbing wave which is detected by the disturbing wave detecting portion is equal to or higher than the predetermined threshold.

3. The receiver according to claim 1, wherein the first front end circuit does not include an LNA but is constituted to connect the antenna to the first mixer, and
the second front end circuit does not include the LNA but is constituted to connect the antenna to the second mixer.

4. The receiver according to claim 1, wherein the first mixer includes a differential input circuit constituted by a pair of transistors, and
the second mixer includes a differential input circuit constituted by a pair of transistors and a resistor connected to sources of the pair of transistors.
